(19) United States
(12) Patent Application Publication
(10) Pub. No.: US 2017/0325427 A1
(43) Pub. Date: Nov. 16, 2017

(54) AUTOMATED, MODULAR, SELF-CONTAINED, AQUAPONICS GROWING SYSTEM AND METHOD

(71) Applicant: FARMPOD, LLC, Santa Fe, NM (US)

(72) Inventors: Michael Carl Straight, Santa Fe, NM (US); Jonathan Henry Beecher Cotton, Santa Fe, NM (US)

(21) Appl. No.: 15/592,716

(22) Filed: May 11, 2017

Related U.S. Application Data
(60) Provisional application No. 62/336,545, filed on May 13, 2016.

(51) Int. Cl. A01K 63/04; A01G 31/06; A01G 31/02; A01G 7/04; A01K 61/85; A01K 61/10; A01K 63/06; A01K 61/95

(52) U.S. Cl. CPC A01K 63/045; A01K 63/065; A01K 63/047; A01G 31/06; A01K 61/95; A01G 7/045; A01K 61/85; A01K 61/10; A01G 31/02

(57) ABSTRACT

A shipping container that includes a greenhouse mounted above an aqueous tank or tanks. Aquaponics fruits and vegetables grow in greenhouse in vertical and horizontal grow systems, while fish are grown in the tanks. Water flows between all plants and fish with no soil. The system is run by a computer automation system which operates on data obtained by various sensors and control components that include automated control valves, fish feeders, temperature and water flow measurements. The container can be operated from an established grid or can run off-grid with solar or other renewable energy sources. Part of the water needed for the system can be collected from rainfall. All necessary components except for the water, fish and plant seedlings are delivered in the shipping container.

### CROSS-REFERENCE TO RELATED APPLICATIONS

This application claims the benefit of U.S. application No. 62/336,545 filed May 13, 2016, the entire content of which is expressly incorporated herein by reference thereto.

### FIELD OF THE INVENTION

The present invention relates generally to growing vegetables and fish. More particularly, the present invention relates to growing vegetables and fish or seafood in a self-contained, computer-automated shippable container aquaponics system.

### BACKGROUND OF THE INVENTION

Existing aquaponics requires expertise to setup, manage and maintain. The term aquaponics refers to the controlled breeding of aquatic organisms, such as for example, fish, crustaceans, mussels, or water plants, such as algae. The aquaculture and the aquaculture technology are an actively developing market globally. Currently, about 30% of the worldwide fishery harvest is met by products from aquaculture.

Conventional aquaculture systems typically require significant amounts of human intervention in order to enable a species of interest to be grown and cultured. Such systems are not closed but instead require partial water changes and the like. In larger systems, significant amounts of water may be needed to be used and disposed of.

Aquaponics is a system of aquaculture in which the waste produced by farmed fish or other aquatic animals supplies nutrients for plants grown hydroponically, which in turn purify the water.

Accordingly, it is desirable to provide an aquaponics method and apparatus that is automated, truly closed, scalable and modular to adapt to environmental and changing food needs to increase efficiency and worldwide use or availability.

### SUMMARY OF THE INVENTION

The foregoing needs are met, to a great extent, by the present invention, wherein in one aspect an apparatus is provided that in some embodiments is automated, truly closed, scalable and modular to adapt to environmental and changing food needs to increase efficiency and worldwide use or availability.

In accordance with one embodiment of the present invention, an automated aquaculture system is provided, with the system comprising at least one fish tank disposed in or as a modular base structure; at least one greenhouse disposed and removably attached atop the at least one base structure; a recirculating water treatment system attached to both the at least one fish tank and the at least one greenhouse including a plurality of valves and pumps; a sensor array disposed within the at least one fish tank, the at least one greenhouse, and the water treatment system; and an automatic monitoring and control system electrically connected to a power system and the sensor array. The automatic monitoring and control system is configured to detect and maintain both a healthy greenhouse environment and a healthy fish tank environment to promote growth and life within each via the sensor array. Also, the recirculating water treatment system includes a main pump, a sump tank, a sump pump, a rain catchment, a reserve tank and a reserve pump with the water treatment system being in fluid flow association with the fish tank(s) with the fluid flow directed by the pumps and controlled by the valves.

The sensor array preferably comprises a plurality of water sensors and a plurality of environmental sensors disposed in the at least one fish tank, the greenhouse or both, and a plurality of flow sensors disposed within the recirculating water treatment system. The plurality of environmental sensors are configured to detect pH, nitrogen, potassium, phosphorus, total dissolved solids, temperature, humidity, rain, sunlight, air and water temperature and oxygen saturation levels within the air and/or water of the at least one greenhouse and the at least one fish tank, respectively.

The system may include a single tank configured and dimensioned for holding water for growing fish, and including netting or mesh to hold different sized fish in different sections of the tank, and an overflow outlet leading to the sump pump for regulating and adjusting proper water level in the tank. Alternatively, the system can include a plurality of fish tanks each configured and dimensioned for holding water for growing fish, with each tank holding different sized fish, and with each tank having overflow outlet leading to the sump pump for regulating and adjusting proper water level in the tank.

Advantageously, the system further comprises at least one feed dispenser disposed within each fish tank, wherein the automatic monitoring and control system is operatively associated with the feed dispenser(s) to automatically dispense food for the fish according to a predetermined schedule. It is preferred, however, to include one or more cameras in or adjacent to the tanks to monitor fish movement and size, with the automatic monitoring and control system operatively associated with the feed dispenser(s) and camera(s) to automatically dispense food for the fish according to data obtained from the monitoring camera(s) and sensors. This tailors the amount of food dispensed to the size and appetite of the fish for optimum growth without over or underfeeding.

The system also preferably includes external system that includes a solar hydronic heat system disposed outside the at least one fish tank and the at least one greenhouse for providing heat to the greenhouse or fish tank(s). The solar hydronic system comprises hydronic solar panels connected to a solar pump module coupled to a heat transfer loop configured to transfer heat to a heated tank, with the tank in selective fluid flow association with the recirculating water treatment system. To allow for continuous operation at night or on cloudy days, the solar hydronic system can further comprise a boiler coupled to the heat transfer loop as a backup heat source and at least one heat storage tank coupled to the heat transfer loop as a heat sink to prevent overheating of the hydronic system.

The solar hydronic system further comprises a plurality of planter tubes configured to provide heat to the at least one greenhouse to maintain a predetermined air temperature and humidity level. Also, the heated tank is typically coupled to the at least one fish tank to provide heated water and to receive cooled water to and from the at least one fish tank to maintain a predetermined water temperature.

For optimum water management and operation, the automatic monitoring and control system is electrically connected to control the sump pump, the reserve pump, and the plurality of valves in the recirculating water treatment system, and the power system comprises one or more of an electric grid tie, photovoltaic solar panels or a battery bank coupled to a charge controller linked to a computer controller.

In another embodiment, the automatic monitoring and control system includes a computer controller comprising at least one processor and at least one memory, and either the at least one fish tank includes lighting therein operatively associated with the computer controller and the sensor array, or the greenhouse includes lighting therein operatively associated with the computer controller and the sensor array, or both the at least one fish tank and the greenhouse includes the lighting therein with the computer controller configured to control the lighting based upon predetermined instructions.

In one aspect, the computer controller triggers the lighting disposed within the at least one fish tank when the sensor array detects a rise or a fall below or above a predetermined value for of any one of pH, nitrogen, potassium, phosphorus, total dissolved solids, temperature, water temperature and oxygen saturation in the water. Similarly, the computer controller triggers the lighting disposed within the at least one greenhouse when the sensor array detects a rise or a fall below or above a predetermined value of any one of nitrogen, potassium, phosphorus, temperature, humidity, rain, and sunlight.

In a preferred alternative embodiment, the lighting is multi-color LED lighting and the computer controller triggers a different color LED as a visual indicator for each type of detected rise or fall below or above the predetermined values that are detected. This allows the system operator to visually see where a problem is occurring so that corrective action can be taken.

The computer controller typically includes input and output sensor array connections and at least one transceiver and is configured to send and receive communications to a laptop computer, tablet computer, smartphone or other user device, so that an alert is sent to the device when the sensor array detects a rise or a fall below or above any of the predetermined values. This is valuable when the operator is away from the system, so that the alert can allow the operator to return to the system to take corrective action. Of course this could also be instituted as part of a maintenance or continuous monitoring procedure so that the system can operate most efficiently and effectively.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 is a block diagram of a computer-controlled automation system of an aquaponics system according to certain embodiments of the disclosure;

FIG. 2 is a flow chart of an aquaponics system according to certain embodiments of the disclosure;

FIG. 3 is an illustration of the equipment described in this invention according to certain embodiments of the disclosure;

FIG. 4 is a block diagram of an electrical system of the aquaponics system of FIG. 2 according to certain embodiments of the disclosure;

FIG. 5 is a block diagram of a solar/hydronic heat system of the aquaponics system of FIG. 2 according to certain embodiments of the disclosure;

FIG. 6 is a block diagram of a main controller of the computer-controlled automation system of the aquaponics system of FIG. 2 according to certain embodiments of the disclosure;

FIG. 7 is a block diagram of a greenhouse of the aquaponics system of FIG. 2 according to certain embodiments of the disclosure; and

FIG. 8 is a block diagram of fish tanks of the aquaponics system of FIG. 2 according to certain embodiments of the disclosure.

### DETAILED DESCRIPTION

The invention will now be described with reference to the drawing figures, in which like reference numerals refer to like parts throughout. An embodiment in accordance with the present invention provides an aquaponics system including a greenhouse portion configured to grow plants or vegetables and a fishery portion configured to grow live fish or seafood, such as crustaceans, mussels, or the like. In some embodiments, the aquaponics system is prebuilt, and all management and maintenance is automated and scalable to meet any growing needs for food. The automation can increase efficiency in both food production yields and minimize the amount of resources consumed. In certain embodiments in accordance with the present invention provides a shippable modular aquaponics system available to be shipped worldwide to, for example, restaurants, resorts, schools, hospitals, grocery stores, villages, towns, homes, distributors, and public aid agencies. This availability may provide fresh nutrient rich food to customers or the needy at chosen locations. In other words, the customer no longer has to hire an expert to manage food production needs, thereby saving the customer time and money. The end result may be making healthy food affordable and available, as needed.

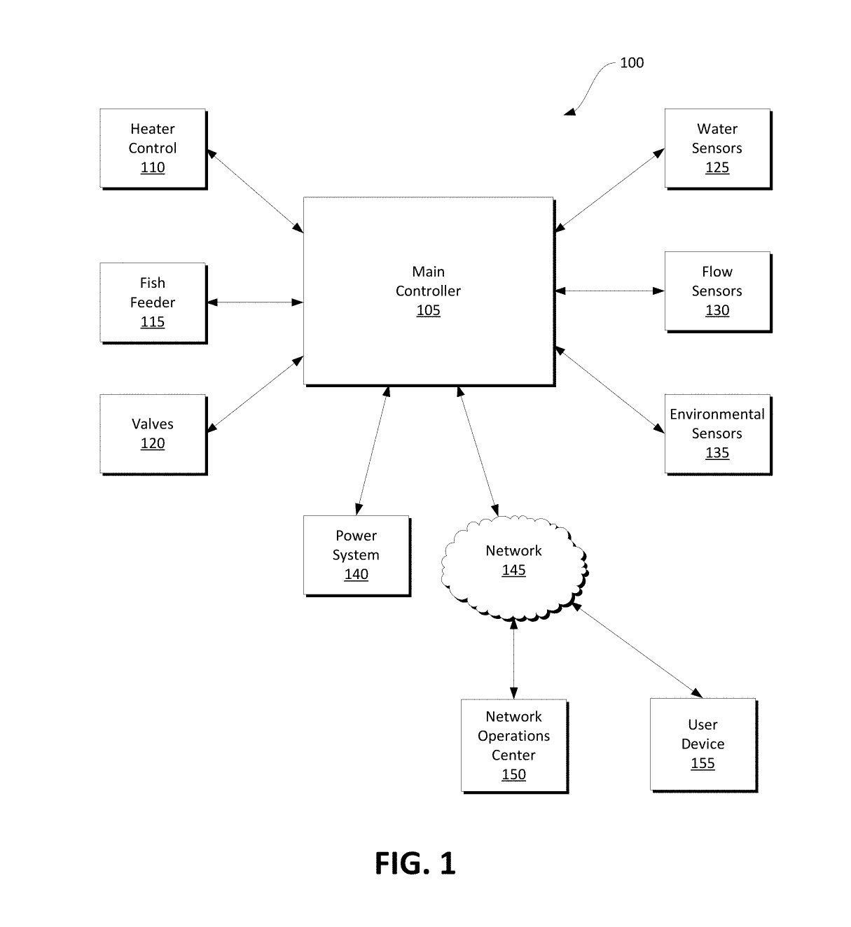

An embodiment of the present inventive apparatus is illustrated in FIG. 1. FIG. 1 is a block diagram of a computer-controlled automation system 100 of an aquaponics system according to certain embodiments of the disclosure. In FIG. 1, automation system 100 includes a main controller 105 electrically connected to a heater control 110, a fish feeder 115, a plurality of valves 120, a plurality of water sensors 125, a plurality of flow sensors 130 including a flow-through spectrometer in some embodiments, a plurality of environmental sensors 135, a power system 140, a network operations center 150 and a user device 155 with the network operations center 150 and the user device 155 configured to be connected to the main controller 105 via a network 145, such as the Internet for example.

In some embodiments, main controller 105 is configured to receive and send input from water sensors 125, flow sensors 130 and environmental sensors 135 in order to trigger actions or processes to be initiated by heater control 110, fish feeder 115, valves 120, power system 140. For example, water sensors 125 may be disposed in fish tanks and configured to detect that water levels are below a predetermined level to the main controller 105 which in turn may be configured to trigger valves 120 to feed water to the fish tanks. Further, flow sensors 130, for example the flow-through spectrometer mentioned above, may be disposed to detect that water flow is below a predetermined level, i.e., a clogged pipe, to the main controller 105 which in turn may be configured to trigger valves 120 to flush the pipe or pipes until the water flow returns to the predetermined level. Further, flow sensors 130, such as the flow-through spectrometer may be configured to provide testing of nitrate and nitrite in the water. Also, environmental sensors 135 may be disposed within a greenhouse and/or fish tanks and may include detection of pH, nitrogen, ammonia, iron, potassium, phosphorus, total dissolved solids, temperature, humidity, rain, sunlight, air temp and oxygen saturation levels within the water. Environmental sensors 135 may be configured to relay the detected levels to main controller 105 which in turn may be configured to trigger or send appropriate action, such as temperature adjustment via the heater control 110 or oxygenating the water or adjusting the pH level, as needed.

In certain embodiments, main controller 105 may be configured to send and receive sensor data to the network operations center 150 and/or to user device 155. Network operations center 150 may include a monitoring system configured to alert users of any problems detected within the aquaponics system, such as a low pH or temperature readings. User device 155 may include mobile devices, such as laptop computers, tablet computers and smartphones, or the like configured to remotely monitor and alert users as to present conditions in the aquaponics system.

Further, main controller 105 may be configured to control and direct the power system 140 of the aquaponics system. In some embodiments, main controller 105 may also be configured to control the activation of the fish feeder 115 to deposit food into the fish tanks based on a predetermined schedule or a visual trigger to feed the fish. In some embodiments, fish feeder 115 may be configured to feed a plurality of fish tanks as a plurality of feeders disposed within each fish tank.

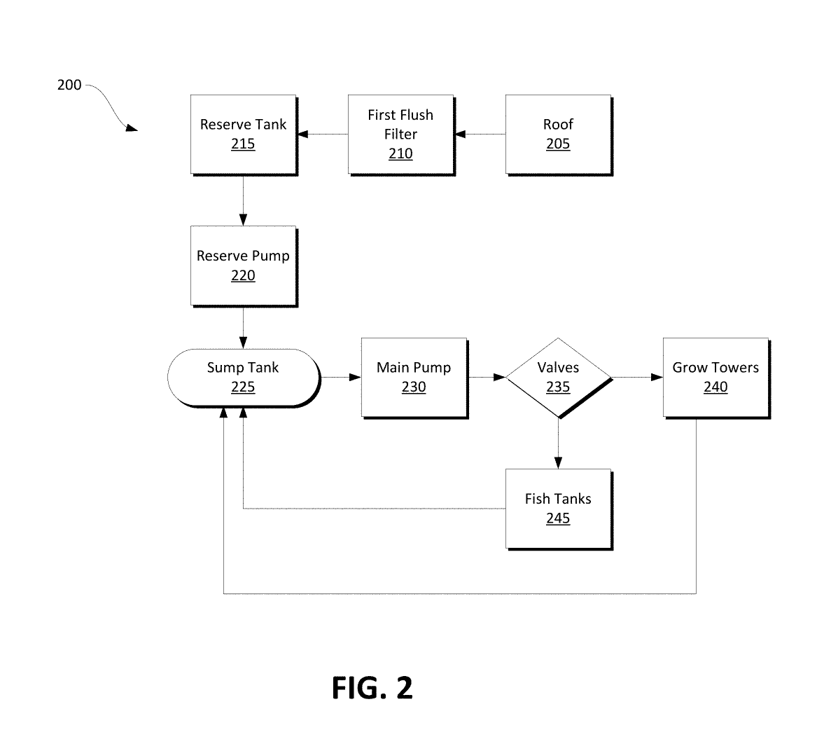

FIG. 2 is a flow chart of an aquaponics system 200 according to certain embodiments of the disclosure. In FIG. 2, aquaponics system 200 may be configured as water leaves a sump tank 225, the water goes to a main pump 230, which is controlled by the main controller 105. In some embodiments, main pump 230 is set at the lowest setting for optimal system health to conserve electricity and maximize plant and fish growth.

When the water leaves the main pump 230, it goes to diverter valves 235 where there are at least two valves in some embodiments. In certain embodiments, valves 235 may coincide with the plurality of valves 120 discussed above. Each valve may be configured to be computer-controlled and may include a flow sensor 130 configured to read water flow. In certain embodiments of system 200, about 700 gallons/hour may be cycling through system 200; 500 gallons/hour pumps to fish tanks 245 and 200 gallons/hour pumps to the greenhouse grow towers 240. The automation of system 200 adjusts the valves 235 accordingly to maintain the above ratios of water flow unless it is otherwise instructed by the main controller 105. When water leaves from the two valves 235, the water flows to two zones of the system 200. Water flows to the fish tanks 245 as a first zone and to the greenhouse grow towers 240 as a second zone. The flow that goes to the fish tanks 245, goes to the tank feeds located on each tank. Each tank feed has a flow control sensor 130 and a computer-controlled valve 120 which regulate the water flow evenly into the tanks 245. In some embodiments, there are a plurality of fish tanks 245 while in other embodiments, fish tanks 245 may comprise a single large tank with sub-sections disposed therein for various sized fish to thrive.

In certain embodiments, aquaponics system 200 is included in a shipping container that includes a greenhouse having grow towers 240 and aqueous fish tanks 245 disposed therein. In some embodiments, aquaponics fruits and vegetables grow in a greenhouse in vertical and/or horizontal grow towers 240, while fish are grown in the fish tanks 245. Water flows between all plants and fish with no soil. The system 200 may be run by the computer automation system 100 which operates on data obtained by various sensors 125, 130 135 and control components that include automated control valves 120, fish feeders 115, temperature and water flow measurements. The container can be operated from any established power source, such as the electrical grid or by an off-grid solar or other renewable energy sources. Part of the water needed for the system 200 can be collected from rainfall and potable water can be used for the balance as needed. All necessary components other than the water, fish and plant seedlings are delivered in the shipping container.

The system 200 includes various sensors and controllers for water flow, distribution, and purity. The container includes one or more fish tanks in the lower portion thereof. The tanks are connected so that fingerlings can grow and then can be transferred to another larger tank as they grow in size. In some embodiments, positioned above the fish tanks 245 may be a greenhouse 310 configured and arranged for providing hydroponic growth of various vegetables or similar crops. No soil is used in the greenhouse as all plants are grown by arranging their roots structures to be contacted with water that is provided from circulating flow from the fish tanks 245.

The container is pre-built and shipped in condition for installation on the user's property. Also, the greenhouse and fish tank(s) also are configured to be shippable and prebuilt. All that is needed when the equipment arrives is general assembly, water, starter solution, fish, and seedlings or plants.

The system 200 is modular so that it is scalable to larger sizes by simply adding additional containers and connecting them either in series or parallel as desired.

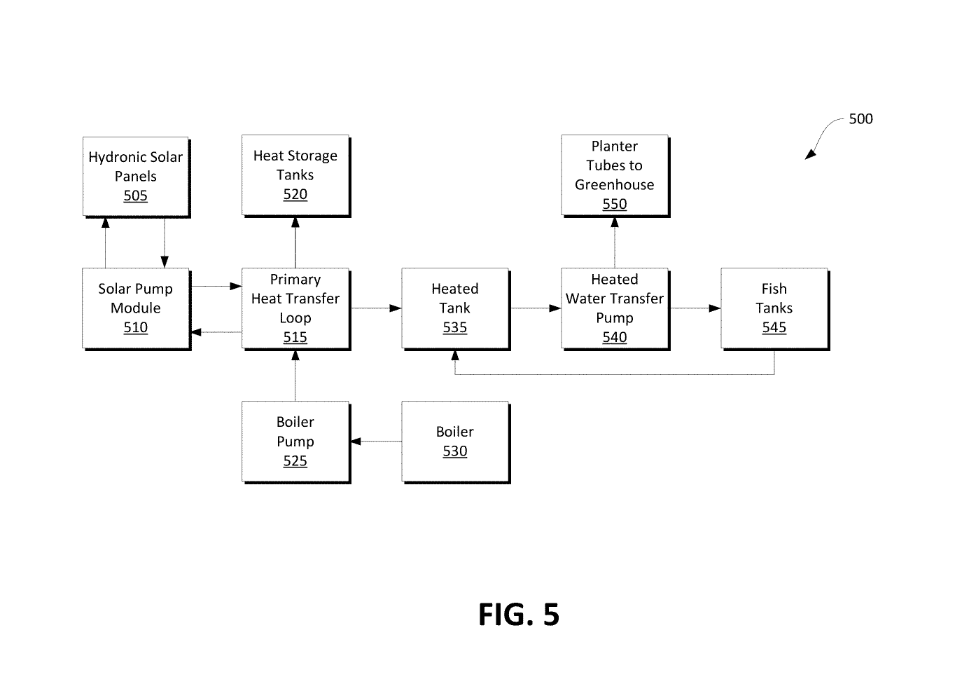

To facilitate growth of the fish, the water temperature in the fish tank is monitored by a sensor 135. This sensor is operatively associated with a heater which can heat the water in the fish tank to a desired preferred temperature. For example with reference to FIG. 5, a submerged, closed loop recirculating heat exchanger connects to a hydronic loop at 515 through a recirculating pump at 540 and back into the tank is provided so that water can be heated before being introduced to raise the temperature of the fish tank to the desired level. Additionally, as a fish feeder 115 is provided for the fish tanks 245. The fish feeder 115 is connected to a computer-controlled motor which dispenses the precise amount of food necessary for feeding at periodic intervals during the day.

The water in the tank is continually circulated so that waste products created by the fish can be removed. The circulation is facilitated by the use of the pump and computer control valves 120.

A further sensor is used to monitor the number of fish in the tank so that the appropriate amount of fish food can be automatically dispensed. The user's only maintenance responsibility in this area is to simply make sure that the fish feeder is provided with sufficient fish food for dispensing. The supply of fish food that is operatively associated with the fish feeder can include the sensor which monitors the level of food in the feeder. The sensor can provide an alarm when the food level becomes too low so that the user can replenish and refill the fish feeder for proper operation.

Environmental sensors 135 are also provided as discussed above. Other sensors determine what is present in the water which also help operate the system for removal of water of inappropriate quality.

The various components and sensors can be interconnected with wireless communication to the main controller 105 which may be located adjacent to tank or in a remote location. The user can monitor the performance of the tank at the main controller 105 to assure that operation is within define parameters. As noted most of the operations are automatic and do not require user intervention.

The automated portions of the container of course require energy. This can be provided by connecting these system to a conventional electrical grid which provides 220 V and/or 110 V AC power, as required. Alternatively, the container can be powered by a renewable energy source such as a solar panel or wind generator. The energy that is generated by such sources can be stored in an appropriate array of batteries for use when the renewable energy is not available. The energy also runs the pumps and valves which are automatically controlled by main controller 105.

The greenhouse 310 may include appropriate grow lighting to assist in providing for photosynthesis of the plants.

The system 200 may require additional water to be added periodically. This can be provided from conventional water mains, but as an alternative a rain collection system can be included to collect and provide added some or all of the additional water needed. Rain is collected from runoff from the roof portion 205 of the greenhouse 310 and is collected in appropriate reserve storage tanks 215 for addition back into the fish tanks 245 when necessary to maintain water level. When insufficient rainfall is collected, water from conventional sources can be provided.

Reserve tank 215 is configured to store reserve rain water or reverse osmosis water for use in the system 200 when system calls for it. The system 200 is configured to prioritize rain catchment from a roof portion 205 via a first flush filter 210 to the reserve tank 215. If the system 200 is connected to the internet 145 and determines rain is in the forecast, it may be configured to wait for the rain before filling the reserve tank 215 with reverse osmosis water. If no rain is available or it is not raining outside, which is determined by a rain sensor 125, the system 200 will trigger a reverse osmosis process.

The water in reserve tank 215 is oxygenated and tested for pH before added to main system when the sump tank 225 calls for it. Reserve tank 215 connects to a reserve pump 220 disposed between reserve tank 215 and the sump tank 225.

In one example of clearing a blockage, if there is a buildup in one tank or lack of oxygen in one tank, then a number of the plurality of valves 235 disposed to control flow into the tank may increase flow to clear the issue.

Grow towers 240 may comprise a plurality of plants or vegetables disposed in either a vertical or horizontal orientation within the greenhouse. The grow towers 240 are configured to receive water as needed in a drip manner. In one example of clearing a blockage, if the drip feed gets clogged, the system 200 will temporarily shut off water to other tower rows that are not clogged and go through a clearing cycle. This clearing cycle may involve closing all other row feed valves 235 and opening only the blocked row feed to allow increased water flow which will clear blockages. The system 200 will do this for all tower rows that are detecting low water flow through the valves 235 via flow sensors 130. After the clearing cycle is complete, the system 200 will return to normal operating flow and verify that the issue is resolved. If issue is not resolved, the main pump 230 will increase pressure by turning up its flow rate. The feed valves 235 to grow towers 240 increases its flow rate. This continues the cleaning process until the problem is resolved.

If the problem is still not resolved in the grow towers 240, the system 200 may notify the user through: indicator lights in the greenhouse 310, it will send out a notification to a user device 155, such as a tablet computer, that may be installed on the wall of container, send an email to a user device 155, such as a smartphone, providing email and/or sent a notification to the data center 150 if the pod is connected to a network/internet 145. It should be noted that when the greenhouse 310 may be in a clearing or cleaning mode, the fish tanks 245 are operating normally as a separate system of valves and water flow.

In the aquaponics system 200, the water chemistry items that are controlled by the main controller 105 include pH, dissolved oxygen, total dissolved solids (TDS)/nutrient load, iron and fish feeding. Once the system 200 is filled and the pumps start circulating, the pH of the system is measured using the pH probe in the sump tank 225. If the pH is above 7.9, the system will operate a dosing pump to draw pH-down solution into the sump tank 225 until it reaches 7.9 pH.

At this point, the user may add a system starting solution that may include a system start up solution kit comprising multiple containers of solution specifically formulated for certain days during the initialization process. For example, on day 1 a solution of pure ammonia at a specific amount calculated by the total amount of water in the system and optionally a healthy bacteria colony starter may be provided. Also, for example, on day 5 a solution of booster ammonia to maintain correct ammonia level may be provided. Further, for example, on day 10 a solution of a second booster ammonia may be provided and on day 14 a solution of liquid seaweed extract and iron may be provided. In addition, the pH can be continuously monitored and should not rise above 7.9. As the system 200 cycles and the natural bacteria are formed into a colony in the grow towers, the pH will slowly trend down over time as carbonates are consumed in the system by bacteria.

Once the system 200 reaches a pH of 6.4, the system will call for the dosing pump to slowly dose the system with pH-up solution until 6.5 pH is reached. This adjustment will continue indefinitely adding small amounts of pH-up solution as needed on a constant basis.

If the system 200 ever reads that the pH is rising on its own, it will initiate notification routine as this is an indication of unhealthy bacteria in the system.

Dissolved oxygen is measured in each fish tank. If dissolved oxygen falls below safe levels, the system 200 will increase the water flow to the tank that is reading low oxygen. It will initiate notification routine as well. If this does not resolve the issue, supplemental oxygen will be provided to the tank until the issue is resolved. If the main pump ever fails, notification routine will be initiated and supplemental oxygen will be provided to all tanks until normal pumping operation is resumed.

Total dissolved solids (TDS) in the system are measured in one or more tanks. If TDS fall below amount needed to provide optimal plant growth, additional feed will be provided to the fish who are able to consume it at that time.

Iron will be added to the system at preprogrammed intervals using a dosing pump. If iron deficiency is noted by the user by visual inspection of plants, the user will call for extra iron to be added to the system through the user interface. In some embodiments, iron may be tested through the flow-through spectrometer and measured accurately in order to maintain optimal or predetermined iron levels automatically in the system.

In certain embodiments, fish are fed on scheduled feeding cycles and amounts. In other embodiments, the main controller 105 may be configured to use underwater cameras and robot learning to detect optimal fish feeding parameters. The underwater cameras will detect the start and stop times when the fish feed while the robot learning which captures such times for future comparisons and feedings.

Sensors 135 in the system may monitor the replenishable supplies (including, but not limited to pH-up, pH-down, iron, and fish food) needed to operate the system and will go through notification routine as needed.

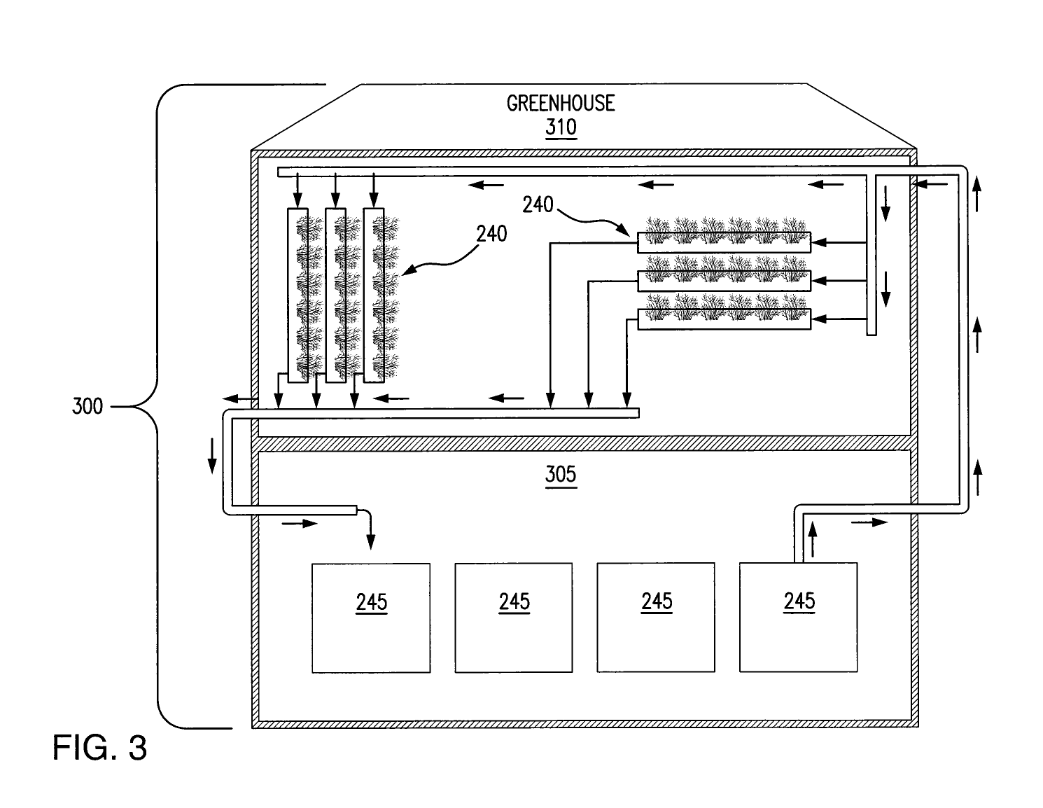

FIG. 3 is an illustration of the equipment/pod 300 described in this invention according to certain embodiments of the disclosure. In FIG. 3, pod 300 may include a container 305 configured to house the fish tanks 245 and related plumbing and sensors. In some embodiments, pod 300 may also include a greenhouse 310 configured to house grow towers 240 disposed in a parallel orientation either vertically or horizontally relative to each other. Both container 305 and greenhouse 310 may be configured as modular portions of pod 300.

In certain embodiments, every tank has a bottom drain 820 which can be controlled automatically by the system or manually by a user in case of emergency if a tank needed to be drained, replaced or cleaned, the tank can be cleaned and water goes outside of the pod 300. The aquaponics system 200 may have a main floor drain in the floor for any overflow, spills, etc. attached to membrane that goes across on the floor. The entire drain line may have a hose attachment to direct water to where it may be needed.

In some embodiments, water from the main pump 230 in the aquaponics system 200 goes to diverter valves which pumps a predetermined and controllable amount of water (gallons/hour) to the greenhouse 310. The water goes up to pipes situated above grow towers 240 to one or more controllable variable valves. The water goes to valves out of a manifold that keeps pressure higher. From the valves, the water flows into tubing inside grow tower headers disposed atop the grow towers 240.

In certain embodiments, each tower 240 has a feed line that feeds a predetermined and controllable amount of water into each tower using a drip line or dripper head. In some embodiments, the water drips through the tower, passes the plants, and drains into the footer at each tower. From the footer, water drains through floor to a drain that goes to sump tank in the container completing greenhouse water flow.

Additionally, the end of each row includes a full size line that goes down to footer from header, which is the same size as what is inside the header. This line has a solenoid valve which is open/close only. When open, the water flows back into footer and back out down the drain the same way as other lines.

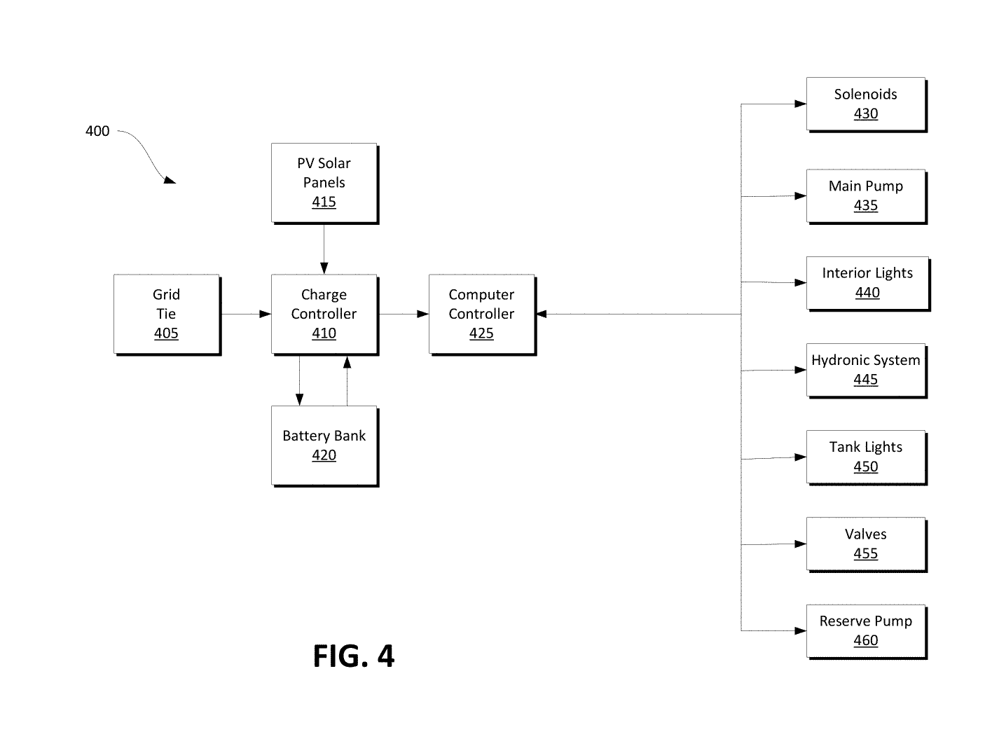

FIG. 4 is a block diagram of an electrical system 400 of the aquaponics system 200 of FIG. 2 according to certain embodiments of the disclosure. In FIG. 4, electrical system 400 may be configured such that the electrical power may be generated in two places, solar photovoltaic (PV) panels 415 and a power grid tie 405. A third option may be connecting the system to an electrical generator in some embodiments. The solar PV panels 415 may be connected directly to the charge controller 410. The grid tie 405 may also be connected to the charge controller 410. When there is not enough energy from the PV panels 415, the charge controller 410 may be configured to connect to the grid tie 405, which can charge both the battery bank 420 and the overall system 400. In some embodiments, the grid tie 405 may include a backup boiler which directly plugs into main or back-up power, 410.

The connected generator may utilize the same process as the grid tie 405. If the grid tie 405 is unavailable, then the system 400 may use a generator. The heat needed for the system 400 comes from heat transfer when cooling the generator.

The charge controller 410 electrically connects to battery bank 420. Both can be charged and the energy may be drawn as needed. The charge controller 410 reports incoming energy and used energy to a computer controller 425. From the computer controller 425, the power and the control are converted to the main pump 435. The computer controller 425 also connects to internal lights 440 in the container, in the greenhouse 310 and outside lights 450. The computer controller 425 further connects to the hydronic system 445 powers and controls, the tank lights 450 in all tanks except rain catchment, the valves 455 throughout the system 400, the reserve pump 220 in reserve tank 215 to power and control the pump and the solenoids 430 in the system 400.

FIG. 5 is a block diagram of a solar/hydronic heat system 500 of the aquaponics system 200 of FIG. 2 according to certain embodiments of the disclosure. In FIG. 5, solar/hydronic heat system 500 may include solar hydronic panels 505, a solar pump module 510, a primary heat transfer loop 515, heat storage tanks 520, a boiler pump 525, a boiler 530, a heated tank 535, a heated water transfer pump 540, fish tanks 545 and planter tubes 550 coupled to greenhouse 310 to provide heat to the greenhouse 310, as needed.

In some embodiments, aquaponics system 200 includes areas that may require additional heating which may be equipped with hydronic hot water panels running on a pressurized heat system 500 with a glycol mixture able to handle most climate zones. The hydronic solar panels 505 disposed on the outside of a container are part of the solar or primary heat transfer loop 515. Loop 515 may be controlled by the main controller 105 as differential heat control. System 500 may be powered by its own pump 510, which is connected to the hydronic loop 515.

When heat is available at the hydronic panels 505 and the system 500 calls for heat (i.e., tanks drop below a predetermined temperature) a heat transfer liquid, typically of a warm glycol solution, is circulated from the hydronic panels 505 to the loop 515. A separate pumping station or solenoid may open the loop that goes through a stainless steel coil that is submerged in the sump tank at 535 or other tanks as needed.

If the fish tanks 545 require heating but no heat is available, the fish tanks 545 will slowly decrease in temperature by an amount that does not affect the plant or fish growth and will slowly cool down. When fish tanks 545 reach a temperature that is too cold to favor fish or plant growth, and there is no outside heat available, the system 500 will pull heat into the loop from a backup heat provider, such as boiler 530 via boiler pump 525. For example, boiler 530 may be an electric boiler, gas boiler, or collected heat off the generators at 530. The backup heat bring the tanks 545 back to the minimum temperature for the system to operate properly and efficiently. The system 500 can also receive heat from sun light via the solar hydronic panels 505, and the system 500 may be configured to prioritize such heat in order to minimize the need for backup energy. Backup energy may be retained in heat storage tanks 520 which are configured to draw and store any excess heat from loop 515.

The hydronic and heating system 500 may be monitored in all fish tanks 545, in the greenhouse 310 at 550, outside the aquaponics system 200 on panels and at multiple points in the circulation loop 515 to maximize efficiency of the operation.

In some embodiments, when too much humidity is measured in the container, the system 500 will turn on an exhaust circulating fan. This fan vents the humid air to the greenhouse if the greenhouse is not too hot to receive it. If so, then the air is vented outside of the unit.

The greenhouse 310 may be configured to operate at specified temperature, which is adjustable depending on the needs of the plants to be grown in it. In a cold environment, the warm water that continually flows through the towers behaves like individual radiators creating a microclimate around each tower. If the greenhouse temperature drops below the greenhouse threshold, the fan will blow and circulate warm air from the container into the greenhouse 310. The circulating air will be heated by blowing across the tanks before returning to the greenhouse 310 to maintain a safe temperature during year round operation. When the desired temperature is reached, the fan shuts off.

Inversely, this process can be used to cool the greenhouse 310 by pulling hot air from the greenhouse 310 and cooling it across the tanks 545 before returning to the greenhouse 310. If temperatures rise above desired threshold and outside air is cooler than that temperature the system 500 turns on an outside fan that blows cool air into greenhouse 310. In extremely warm climates, solar air conditioning can be used as well for cooling of the greenhouse 310.

For further control of the greenhouse temperature, the windows in the greenhouse 310 can open or close automatically based on the sensed outside temperature. Additionally, these windows will close when adverse weather conditions are detected outside of the Pod.

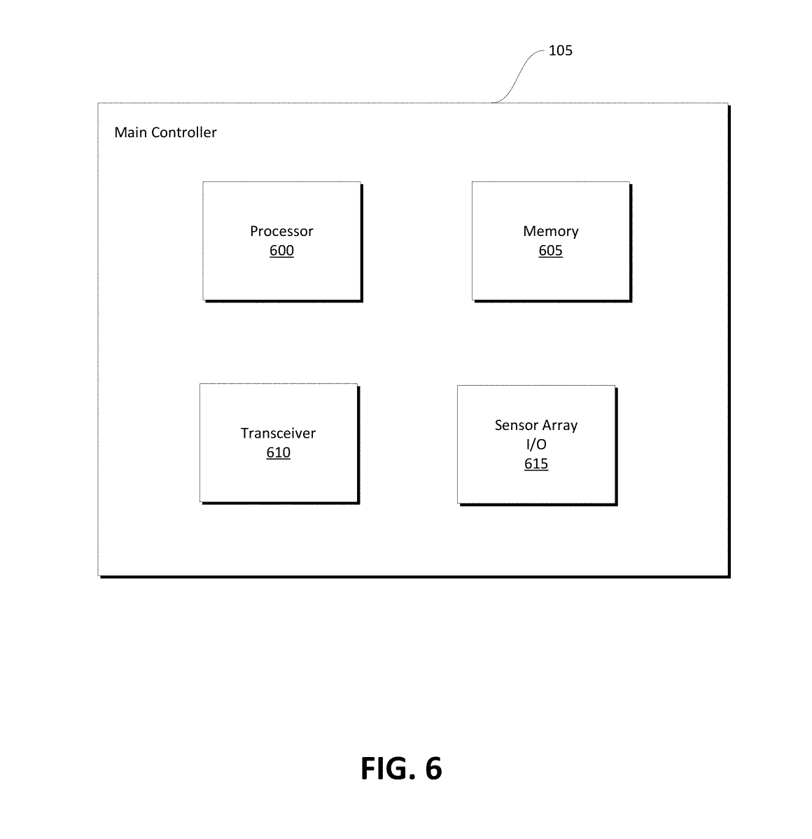

FIG. 6 is a block diagram of a main controller 105 of the computer-controlled automation system 100 of the aquaponics system 200 of FIG. 2 according to certain embodiments of the disclosure. In FIG. 6, main controller 105 may include at least one processor 600, at least one memory 605, a transceiver 610 and a sensor array I/O 615. The processor 600 is configured to execute program code or instructions and the memory 605 is configured to store and retrieve the same as well as ROM or RAM. The transceiver 610 is configured to transmit and receive communication signals, such as mobile communications, Internet communications, or the like. Sensor array I/O 615 is configured to electrically connect to water sensors 125, flow sensors 130 and environmental sensors 135, or the like.

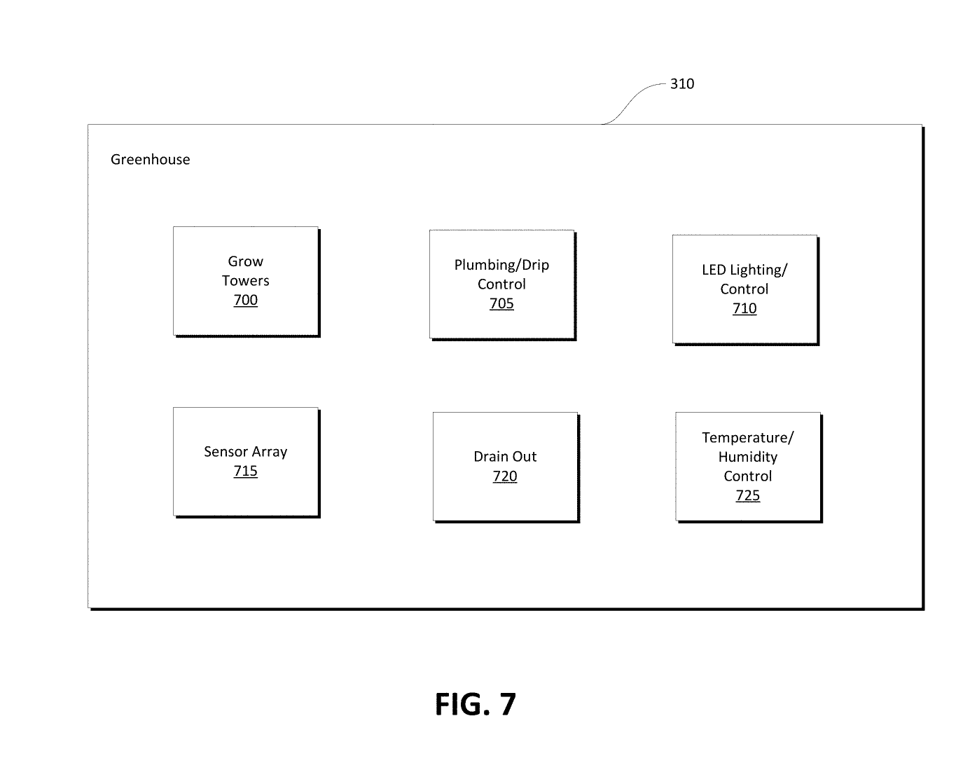

FIG. 7 is a block diagram of a greenhouse 310 of the aquaponics system 200 of FIG. 2 according to certain embodiments of the disclosure. In FIG. 7, greenhouse 310 may include grow towers 700, which in some embodiments may coincide with grow towers 240 discussed above, plumbing/drip control 705 configured to regulate water drip for plant growth, LED lighting/control 710 configured to provide visual indicators to users as to the status of the greenhouse, i.e., humidity, temperature, etc., sensor array 715, which in some embodiments may coincide with the environmental sensors 135 discussed above, configured to detect the humidity, temperature, etc. within the greenhouse 310, drain out 720 configured to drain from the grow towers 700 to the sump tank 225, and temperature/humidity control 725 configured to trigger cool and hot fan operation, open and close exterior windows operations when the temperature or humidity, for example, reach undesirable levels as detected via the sensor array 715 within the greenhouse.

In some embodiments, the LED lighting/control 710 may be configured to visually indicate predetermined conditions within the greenhouse 310. For example, a red LED light may indicate a state in which the greenhouse temperature is too high for the plants and a blue LED light may indicate a state in which the temperature is too low for the plants. A green LED light may indicate that the humidity in the greenhouse 310 is below a predetermined level, etc. These LED light colors may tell a user visually what needs attention within the greenhouse 310. In certain embodiments, the LED lights may be disposed either within each tank or external to each tank. When the LED lights are disposed within each tank, then the tanks would be constructed of a translucent or transparent material to provide a readily visible indicator to a user.

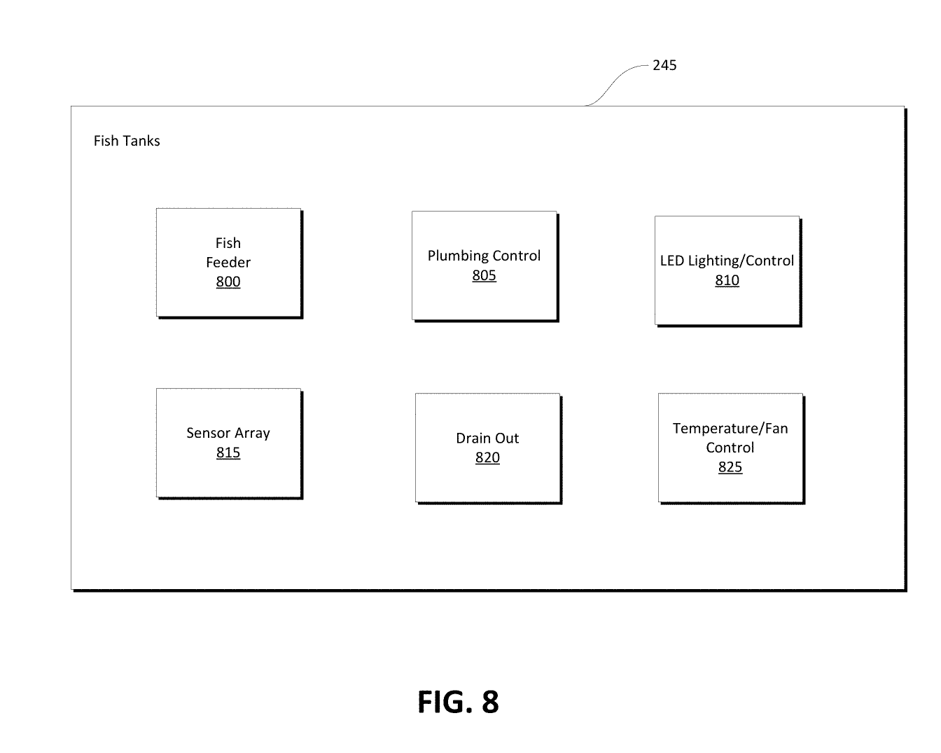

FIG. 8 is a block diagram of fish tanks 245 of the aquaponics system 200 of FIG. 2 according to certain embodiments of the disclosure. In FIG. 8, fish tanks 245, which in some embodiments may coincide with first tanks 335 or 545 discussed above, may include a fish feeder 800, which in some embodiments may coincide with fish feeder 115 discussed above, a plumbing control 805, which in some embodiments may coincide with valves 120 discussed above, LED lighting/control 810, which in some embodiments may coincide with 710 discussed above, sensor array 815, which in some embodiments coincide with environmental sensors 135 discussed above, drain out 820 configured to recirculate fresh water to the fish tanks 245 when needed to maintain pH levels, water levels or the like, and temperature/fan control 825 configured to maintain a predetermined temperature within and around fish tanks 245 to maintain healthy fish.

In some embodiments, the LED lighting/control 810 may be configured to visually indicate predetermined conditions within the fish tanks 245. For example, a red LED light may indicate a state in which the fish tank temperature is too high for the fish and a blue LED light may indicate a state in which the temperature is too low for the fish. A green LED light may indicate that the pH in the fish tanks 245 is below a predetermined level, etc. These LED light colors may tell a user visually what needs attention within the fish tanks 245.

The overall arrangement of the fish tanks and greenhouse is shown in FIG. 9.

The aquaponics system 200 makes growing food user friendly through automating the aquaponics and growing environment. This has a two-fold benefit in that the user only needs to focus on growing and harvesting plants and fish. This allows for a significant reduction of labor costs and overhead. A healthy aquaponics system 200 is virtually taken care of by the automation system 100 so the knowledge, work, and time required is minimized.

The present aquaponics system 200 delivers a system that is prebuilt and shippable thereby delivering a complete package to the user. Further, standard components of the aquaponics system 200 are configured to fit within a shipping container for simple and secure shipping.

In certain embodiments, all components are ordered and delivered as a modular unit. Thus, all components that operate inside the shipping container are pre-assembled and pre-installed for the user. All relevant parts are quality assurance tested at a manufacturing facility. All external components may be packed inside the shipping container and delivered as a unit to the user. The assembly process includes installing the greenhouse 310 on top of the shipping container, connecting prebuilt greenhouse plumbing modules, mounting supports for grow towers 240, installing grow towers 240, installing optional components, such as stairs, etc. Water, fish and plants may then be added by the user. Particular requirements may exist for types of fish and plants. For example, most fresh water fish may work in the system, such as, catfish, tilapia, barramundi, trout, bluegill, sunfish, crappie, crawfish, large-mouth bass, perch, pacu, sleepy cod, coi and goldfish. As for plants any leafy plant, for example, lettuce, pak choi, kale, swiss chard, arugula, basil, mint, rosemary, thyme, sage, oregano, cilantro, watercress, chives, tomatoes, cucumbers, corn, peppers, beans, peas, squash, broccoli, cauliflower, cabbage, edible flowers, dwarf citrus trees, micro greens, as well as most common houseplants. Further, in some embodiments, beets, carrots, onions and radishes may be grown.

In some embodiments, an extended package may include a greenhouse footprint that is that of the shipping container plus additional attached greenhouse space varying in size, shape or quantity as desired by the user.

In operation, when fish, such as Fry are born they are collected and moved to a breeding fish tank. Once fish reach fingerling size they are moved into the fish tanks 245 to continue growing. In some embodiments, fish can either mature as a group or larger fish maybe moved to a larger fish tank, as needed. When fish are desired they can be harvested and consumed or sold. Additional fish and/or crawfish may live and grow in the sump tank 225 for the purpose of further natural filtration. As the user harvests fish, the automation system 100 is configured to sense changes in the water via sensors 135 and automatically adjusts the food provided to the fish via fish feeder 115. All the user needs to do is fill the automated fish feeders 115.

The user desired plants may be started from seed in plugs or taken from clones of existing plants using standard cloning practices. After a few days when roots are set and plants are stable, the user then moves the plants from the plugs or clones into the vertical and/or horizontal grow towers 240 in the greenhouse 310. User then may harvests plants as desired and replant as needed. All other maintenance and operations of the aquaponics system 200 may be performed by the main controller 105 and its attached sensors and devices, as shown in FIG. 1.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An automated aquaculture system, comprising:
at least one fish tank disposed in or as a modular base structure;
at least one greenhouse disposed and removably attached atop the at least one base structure;
a recirculating water treatment system attached to both the at least one fish tank and the at least one greenhouse including a plurality of valves and pumps;
a sensor array disposed within the at least one fish tank, the at least one greenhouse, and the water treatment system; and
an automatic monitoring and control system electrically connected to a power system and the sensor array;
wherein the automatic monitoring and control system is configured to detect and maintain both a healthy greenhouse environment and a healthy fish tank environment to promote growth and life within each via the sensor array; and
wherein the recirculating water treatment system includes a main pump, a sump tank, a sump pump, a rain catchment, a reserve tank and a reserve pump with the water treatment system being in fluid flow association with the fish tank(s) with the fluid flow directed by the pumps and controlled by the valves.

2. The system according to claim 1, wherein the sensor array comprises a plurality of water sensors disposed in the at least one fish tank and a plurality of flow sensors disposed within the recirculating water treatment system.

3. The system according to claim 2, wherein the sensor array further comprises a plurality of environmental sensors disposed in both the at least one greenhouse and the at least one fish tank.

4. The system according to claim 3, wherein the plurality of environmental sensors are configured to detect pH, nitrogen, potassium, phosphorus, total dissolved solids, temperature, humidity, rain, sunlight, air and water temperature and oxygen saturation levels within the air and/or water of the at least one greenhouse and the at least one fish tank, respectively.

5. The system according to claim 1, wherein the at least one fish tank is a single tank configured and dimensioned for holding water for growing fish, and including netting or mesh to hold different sized fish in different sections of the tank, and an overflow outlet leading to the sump pump for regulating and adjusting proper water level in the tank.

6. The system according to claim 1, wherein the at least one fish tank is a plurality of tanks each configured and dimensioned for holding water for growing fish, with each tank holding different sized fish, and with each tank having overflow outlet leading to the sump pump for regulating and adjusting proper water level in the tank.

7. The system according to claim 1, further comprising at least one feed dispenser disposed within each fish tank, wherein the automatic monitoring and control system is operatively associated with the feed dispenser(s) to automatically dispense food for the fish according to a predetermined schedule.

8. The system according to claim 1, further comprising at least one feed dispenser disposed within each fish tank and one or more cameras to monitor fish movement and size, wherein the automatic monitoring and control system is operatively associated with the feed dispenser(s) and camera(s) to automatically dispense food for the fish according to data obtained from the monitoring camera(s).

9. The system according to claim 1, further comprising an external system that includes a solar hydronic heat system disposed outside the at least one fish tank and the at least one greenhouse for providing heat to the greenhouse or fish tank(s).

10. The system according to claim 9, wherein the solar hydronic system comprises photovoltaic solar panels connected to a solar pump module coupled to a heat transfer loop configured to transfer heat to a heated tank, with the tank in selective fluid flow association with the recirculating water treatment system.

11. The system according to claim 10, wherein the solar hydronic system further comprises a boiler coupled to the heat transfer loop as a backup heat source and at least one heat storage tank coupled to the heat transfer loop as a heat sink to prevent overheating of the hydronic system.

12. The system according to claim 10, wherein the solar hydronic system further comprises a plurality of planter tubes configured to provide heat to the at least one greenhouse to maintain a predetermined air temperature and humidity level.

13. The system according to claim 10, wherein the heated tank is coupled to the at least one fish tank to provide heated water and to receive cooled water to and from the at least one fish tank to maintain a predetermined water temperature.

14. The system according to claim 1, wherein the automatic monitoring and control system is electrically connected to control the sump pump, the reserve pump, and the plurality of valves in the recirculating water treatment system, and wherein the power system comprises one or more of an electric grid tie, photovoltaic solar panels or a battery bank coupled to a charge controller linked to a computer controller.

15. The system according to claim 1, wherein the automatic monitoring and control system includes a computer controller comprising at least one processor and at least one memory; and wherein the at least one fish tank includes lighting therein operatively associated with the computer controller and the sensor array, the greenhouse includes lighting therein operatively associated with the computer controller and the sensor array, or both the at least one fish tank and the greenhouse includes the lighting therein with the computer controller configured to control the lighting based upon predetermined instructions.

16. The system according to claim 15, wherein the computer controller triggers the lighting disposed within the at least one fish tank when the sensor array detects a rise or a fall below or above a predetermined value for of any one of pH, nitrogen, potassium, phosphorus, total dissolved solids, temperature, water temperature and oxygen saturation in the water, and the computer controller triggers the lighting disposed within the at least one greenhouse when the sensor array detects a rise or a fall below or above a predetermined value of any one of nitrogen, potassium, phosphorus, temperature, humidity, rain, and sunlight.

17. The system according to claim 16, wherein the lighting is multi-color LED lighting and the computer controller triggers a different color LED as a visual indicator for each type of detected rise or fall below or above the predetermined values that are detected.

18. The system according to claim 16, wherein the computer controller further comprises input and output sensor array connections and at least one transceiver and is configured to send and receive communications to a laptop computer, tablet computer, smartphone or other user device, and an alert is sent to the device when the sensor array detects a rise or a fall below or above any of the predetermined values.
